(19) United States
(12) Patent Application Publication
(10) Pub. No.: US 2003/0089774 A1
(43) Pub. Date: May 15, 2003

(54) Apparatus and method for reading magnetic stripes

(76) Inventors: Daniel J. Schmieder, Los Angeles, CA (US); Robert S. DeLand JR., Torrance, CA (US)

Correspondence Address: CHRISTIE, PARKER & HALE, LLP, P.O. BOX 7068, PASADENA, CA, 91109-7068, US

(21) Appl. No.: 10/222,169

(22) Filed: Aug. 15, 2002

Related U.S. Application Data
(60) Provisional application No. 60/312,444, filed on Aug. 15, 2001.

(51) Int. Cl. G06K 7/08

(52) U.S. Cl. 235/449

(57) ABSTRACT

Apparatus and methods are described for identifying desired data recorded in a magnetic media based on the density in which the data is recorded in the media. In one embodiment the invention includes a first magnetic reading head connected to a first intermediate network, a second magnetic reading head connected to a second intermediate network and a logic unit connected to the first and second intermediate networks, where the logic unit is configured to compare the rates at which flux transitions occur at the first and second reading heads.

### CROSS-REFERENCE TO RELATED APPLICATION

This application claims priority on U.S. provisional application No. 60/312,444 filed on Aug. 15, 2001, the content of which is incorporated herein by reference.

### BACKGROUND OF THE INVENTION

This invention relates to magnetic stripe readers and in particular to magnetic stripe readers capable of reading data from one stripe of a card that has two or more magnetic stripes.

The use of magnetic stripes to store data is widely prevalent. Magnetic stripes are found on the back of credit cards, on security access cards and in a variety of other applications.

The international standard ISO 7811 provides a standard for the storage of data on a card using a magnetic stripe. The standard specifies that each card has a single stripe containing data that is represented using alternating magnetic fields. The magnetic stripe is divided into three tracks. Tracks 1 and 3 contain data with a density of 210 bits per inch (“b.p.i.”) and track 2 contains data with a density of 75 b.p.i.

Magnetic stripe readers designed to retrieve data stored in the magnetic stripe of an ISO 7811 card typically have a single reading head. When the reading head is proximate the magnetic stripe, the reading head can detect magnetic flux transitions caused by the movement of the stripe relative to the reading head. When the magnetic stripe is being read, the reader obtains the data stored in the magnetic stripe using the signal output by the reading head.

Magnetic stripe readers that only have one reading head are limited in that the card containing the magnetic stripe must be properly aligned relative to the reading head in order for the reader to obtain the data stored in the magnetic stripe. To overcome this limitation, magnetic stripe readers have been designed with more than one reading head so that the magnetic stripe will always be proximate one of the reading heads, when the magnetic stripe is being read by the reader.

ISO 7811 magnetic stripe readers possessing multiple reading heads can have problems reading data because they assume that the card possesses a single magnetic stripe. Many cards contain an ISO 7811 magnetic stripe and additional magnetic stripes. Such cards include cards compliant with Japanese Industrial Standard JIS X 6302, which have an ISO 7811 magnetic stripe on one side and a second stripe containing a single track of data with a density of 210 b.p.i. located on the other side of the card. When a card with more than one stripe is read by a reader possessing multiple reading heads, then more than one of the reading heads will detect magnetic flux transitions. If more than one of the reading heads detects flux transitions, then the reader has difficulty determining which reading head is detecting the flux transitions associated with the ISO 7811 stripe.

One solution is to obtain the data from all of the reading heads that detect flux transitions. Once the data is obtained, a decode processor can inspect the data and extract the desired information.

A disadvantage of using a decode processor to inspect the obtained data is the high cost of upgrading an existing magnetic stripe reading system that has a single reading head to a magnetic stripe reading system including multiple reading heads. An upgrade that relies on the decode processor to inspect the obtained data is expensive because magnetic stripe reading systems are typically embedded. Therefore, increasing the functionality of the decode processor would require replacing the entire system.

### SUMMARY OF THE INVENTION

The present invention provides a method and apparatus for reading data from a single magnetic stripe of a device having two or more magnetic stripes, where at least a portion of one of the tracks of data on the magnetic stripe that is read has a b.p.i. density that differs from the b.p.i. density of the data recorded on the same track of the other magnetic stripes.

In one embodiment, the invention includes a first magnetic reading head connected to a first intermediate network, a second magnetic reading head connected to a second intermediate network and a logic unit connected to the first and second intermediate networks, where the logic unit is configured to compare the rates at which flux transitions occur at the first and second reading heads. In further embodiments each magnetic reading head and intermediate network pair is configured to generate a signal indicative of the magnetic field of a magnetic stripe moving relative to the reading head. In further embodiments again, the first and second intermediate networks include an amplifier/detector connected to a bit recovery unit. In alternative embodiments, the logic unit is configured to select one of the first or second magnetic reading heads based on the detected difference in the rate of flux transitions experienced by the magnetic reading heads and the logic unit is configured to output bits of information based on the flux transitions occurring at the selected magnetic reading head. In addition, the logic unit can be configured to detect the presence of a card containing at least two magnetic stripes and in embodiments where the magnetic stripes on the card contain padding bits, the logic unit can be configured to select a magnetic reading head prior to all of the padding bits on either of the magnetic stripes being read by the magnetic reading heads.

In another alternative embodiment, the logic unit is configured to select one of the magnetic stripes on the card based on the density of data recorded on individual tracks of the magnetic stripes. In yet another alternative embodiment, the invention includes means for detecting bits of data recorded in a first track of magnetic data, means for detecting bits of data recorded in a second track of magnetic data, means for detecting a difference in the density with which bits are recorded in the first track of magnetic data and the density with which bits are recorded in the second track of magnetic data.

A still further embodiment again of the invention includes the steps of analyzing flux transitions recorded on a track of data on each of a first magnetic stripe and a second magnetic stripe and using the measured flux transitions to identify the magnetic stripe containing the desired data. Still yet another further embodiment includes the steps of detecting the presence of more than one magnetic stripe, reading the desired data from the magnetic stripe identified as containing the desired data. In still another further embodiment again, the data contained on each of the magnetic stripes includes a number of padding bits and the analyzing step further includes the steps of simultaneously reading the padding bits on each of the magnetic stripes and counting the number of bits read from each of the magnetic stripes. In still yet another further embodiment the analyzing step further comprises the step of comparing the bit counts of each of the magnetic stripes.

### BRIEF DESCRIPTION OF THE DRAWINGS

FIG. 1 is a block diagram schematically illustrating components of a magnetic stripe reader;

FIG. 2 is a flow chart illustrating a process for reading desired data from a magnetic stripe, when more than one magnetic stripe may be present;

FIGS. 3A and 3B are side views of a card possessing two magnetic stripes; and

FIG. 4 is a circuit diagram illustrating a magnetic stripe reader having two reading heads each reading two tracks of data.

### DETAILED DESCRIPTION OF THE INVENTION

Referring to the drawings, magnetic stripe readers 100 in accordance with the present invention are illustrated. The magnetic stripe readers include magnetic reading heads that generate signals containing information concerning the density with which tracks of data are recorded on magnetic stripes. The magnetic stripe readers can use data density information to identify magnetic stripes or tracks that contain desired data.

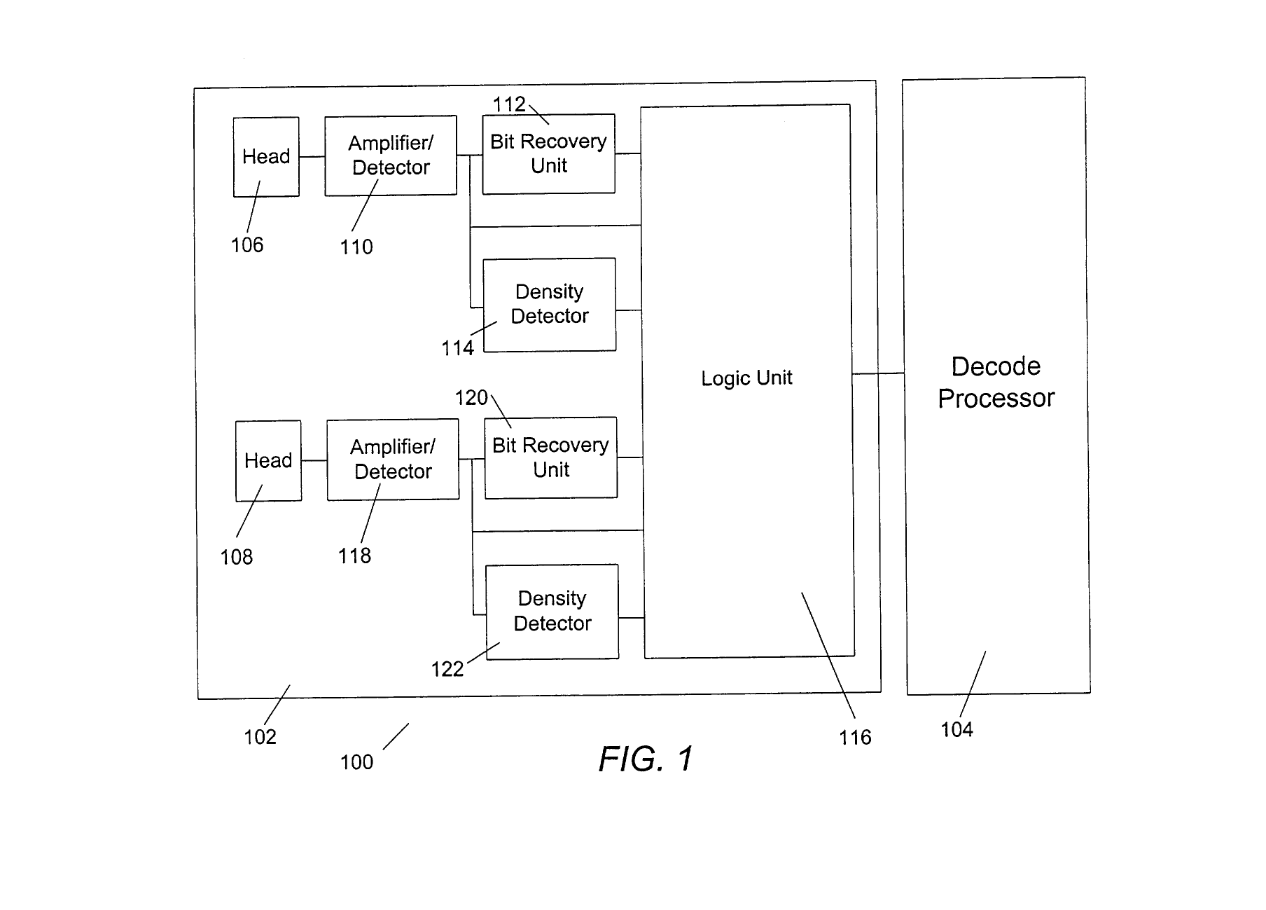

A magnetic stripe reader in accordance with the present invention is illustrated in FIG. 1. The magnetic stripe reader includes a detection and bit recovery unit 102 that reads data in the form of flux variations from a magnetic stripe and converts the data into a digital signal. If more than one magnetic stripe is detected, the detection and bit recovery unit determines which stripe contains the data sought by the decode processor and outputs this data as a digital signal. The detection and bit recovery unit is connected to a decode processor 104 that extracts information from the digital signal received from the detection and bit recovery unit and performs functions using the extracted information.

The detection and bit recovery unit of FIG. 1 includes a first reading head 106 and a second reading head 108. In one embodiment, the reading heads are implemented using a 68100065 manufactured by Mag-Tek of Carson, Calif. In other embodiments, the detection and bit recovery unit includes more than two reading heads.

The first reading head is connected to an amplifier detector 110. The first reading head generates an electric signal in response to the magnetic flux detected near the reading head. The electrical signal generated by the first reading head is provided to the first amplifier/detector.

The first amplifier/detector is connected to a first bit recovery unit 112, a first density detector 114 and a logic unit 116. The first amplifier/detector receives the electrical signal from the first reading head and uses the electrical signal to determine if there has been a magnetic flux transition. The first amplifier/detector then generates a signal indicating that there has been a magnetic flux transition and this signal is provided to the first bit recovery unit, the first density detector and the logic unit.

The first bit recovery unit is connected to the logic unit. The first bit recovery unit receives a signal from the first amplifier/detector indicating a flux transition and converts the received signal into a digital signal, which is provided to the logic unit.

The first density detector is connected to the logic unit. The first density detector receives signals from the first amplifier/detector indicating the detection of flux transitions and measures the rate with which the flux transitions occur at the first reading head. The first density detector outputs a signal to the logic unit indicative of this rate.

The second reading head 108 is connected to a second amplifier/detector 118. The second amplifier/detector 118 is connected to a second bit recovery unit 120, a second density detector 122 and the logic unit. The second amplifier/detector, the second bit recovery unit and the second density detector perform identical functions to the first amplifier/detector, the first bit recovery unit and the density detector. In one embodiment, the first amplifier/detector, the first bit recovery unit and the first density detector can be implemented using an 21006515 DIP integrated circuit (“IC”) manufactured by Mag-Tek. Likewise, the second amplifier/detector, the second bit recovery unit and the second density detector can also be implemented using a 21006515 IC.

In the embodiments described above, the first and second amplifier/detectors, the first and second bit recovery units and the first and second density detectors form first and second intermediate networks. An intermediate network in accordance with the present invention takes a signal generated by a magnetic reading head and provides either the signal generated by the magnetic reading head or a signal indicative of the signal generated by the magnetic reading head to the logic unit. In other embodiments, intermediate networks are provided that can be implemented using various discrete components, a microprocessor or using discrete components in combination with a microprocessor.

The logic unit 116 receives signals from the first amplifier/detector, the second amplifier/detector, the first bit recovery unit, the second bit recovery unit, the first density detector and the second density detector. The logic unit uses the signals from the amplifier/detectors to determine whether data is being read from a magnetic stripe by one of the reading heads. If data is being read from magnetic stripes by both the first reading head and the second reading head, then the logic unit uses the output of the density detectors to determine the relative densities of the data contained on the magnetic stripe being read by the first reading head and the magnetic stripe being read by the second reading head. The logic unit selects the output of either the first bit recovery unit or the second bit recovery unit based on the relative data densities of the magnetic stripes. The logic unit provides the selected output to the decode processor.

In one embodiment, the logic unit can be implemented using discrete electronic components. In other embodiments the logic unit can be implemented using an application specific integrated circuit or a microprocessor. In addition, the logic units can be implemented using a combination of application specific integrated circuits, microprocessors and/or discrete components

In other embodiments, the magnetic stripe reader includes more than two reading heads. In embodiments possessing more than two reading heads, the detector and bit recovery unit includes additional amplifier/detectors, bit recovery units and density detectors and the logic unit is adapted to receive signals from at least two of the amplifier/detectors, bit recovery units and density detectors.

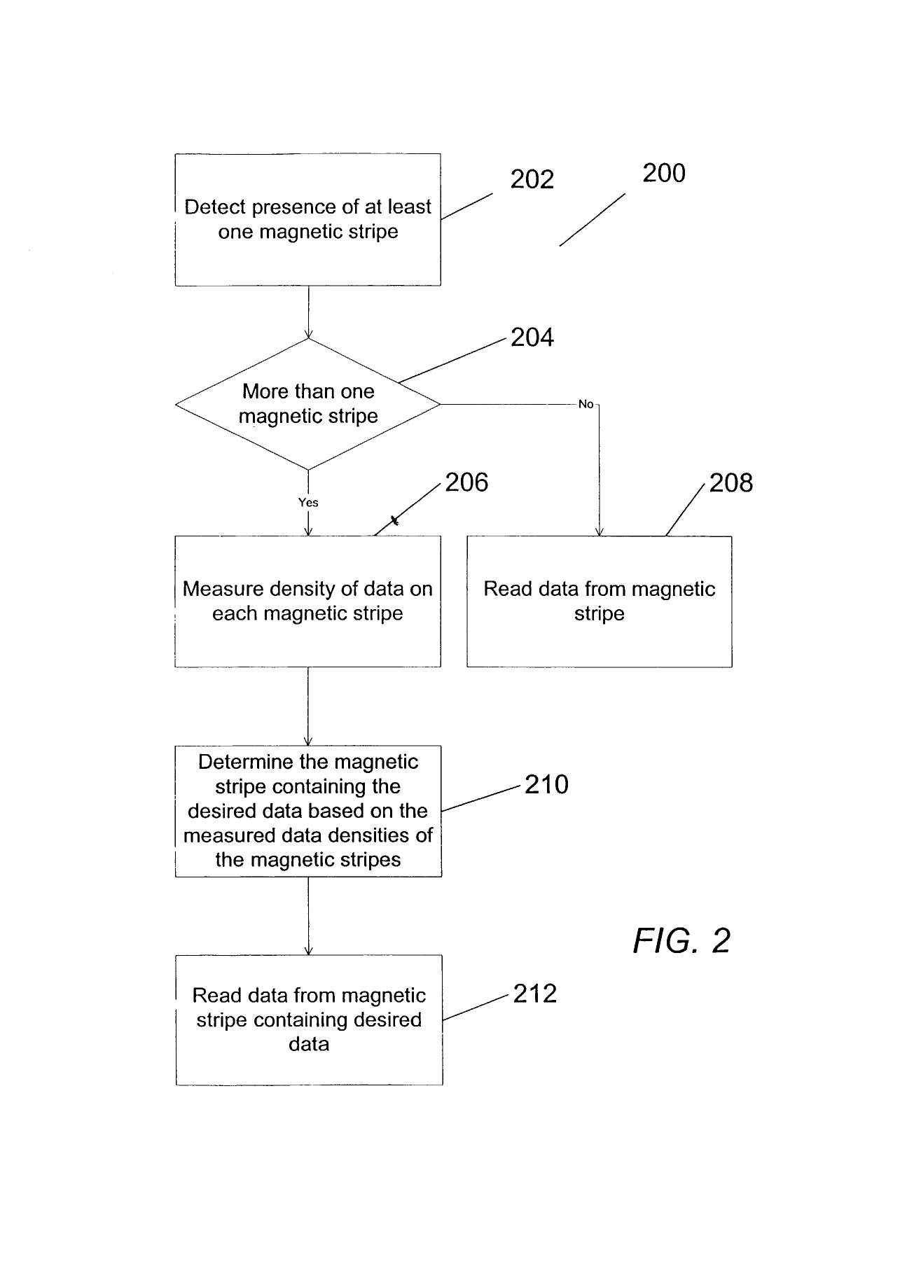

A flow diagram showing a process 200 used by a magnetic stripe reader in accordance with the present invention to obtain desired data from one or more magnetic stripes is illustrated in FIG. 2. The process 200 commences when the reader 100 detects the presence of at least one magnetic stripe in the block 202.

The reader performs the decision 204 in light of the number of magnetic stripes detected. If only a single magnetic stripe is detected, than the reader reads data from that magnetic stripe in the block 208. If more than one magnetic stripe is present, then the reader measures the density of data on each of the magnetic stripes in the block 206 and proceeds to the block 210.

In the block 210, the reader determines which magnetic stripe contains the desired data using the measured data densities of the magnetic stripes. Once the reader has determined which magnetic stripe contains the desired data, the reader reads the data from the magnetic stripe containing the desired data in the block 212.

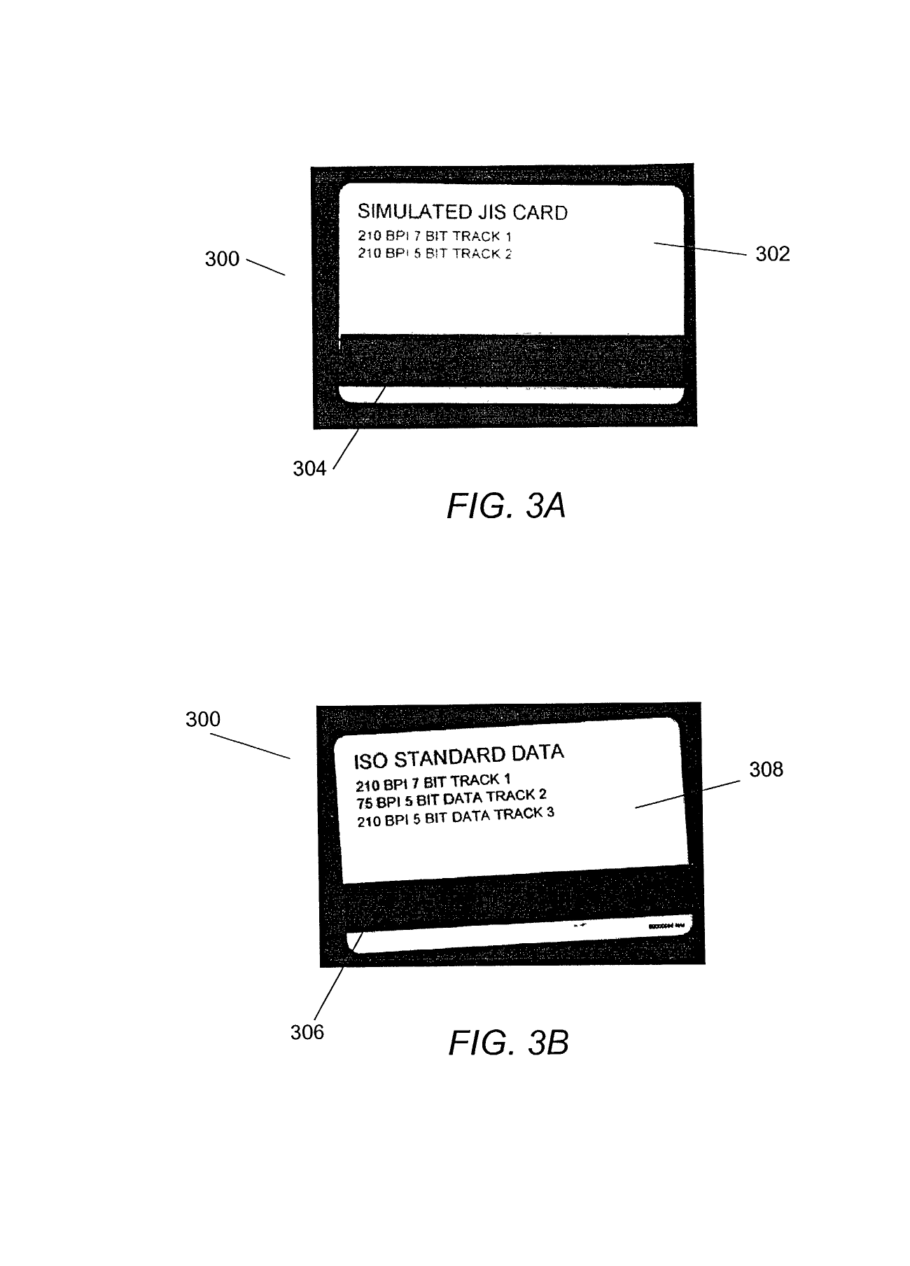

FIGS. 3A and 3B illustrate a card 300 possessing a first magnetic stripe 302 on the front face of the card 304 and a second magnetic stripe 306 on the back face of the card 308. The first magnetic stripe complies with ISO 7811 and the second magnetic stripe complies with JIS X 6302. ISO 7811 and JIS X 6302 are incorporated herein by reference in their entirety.

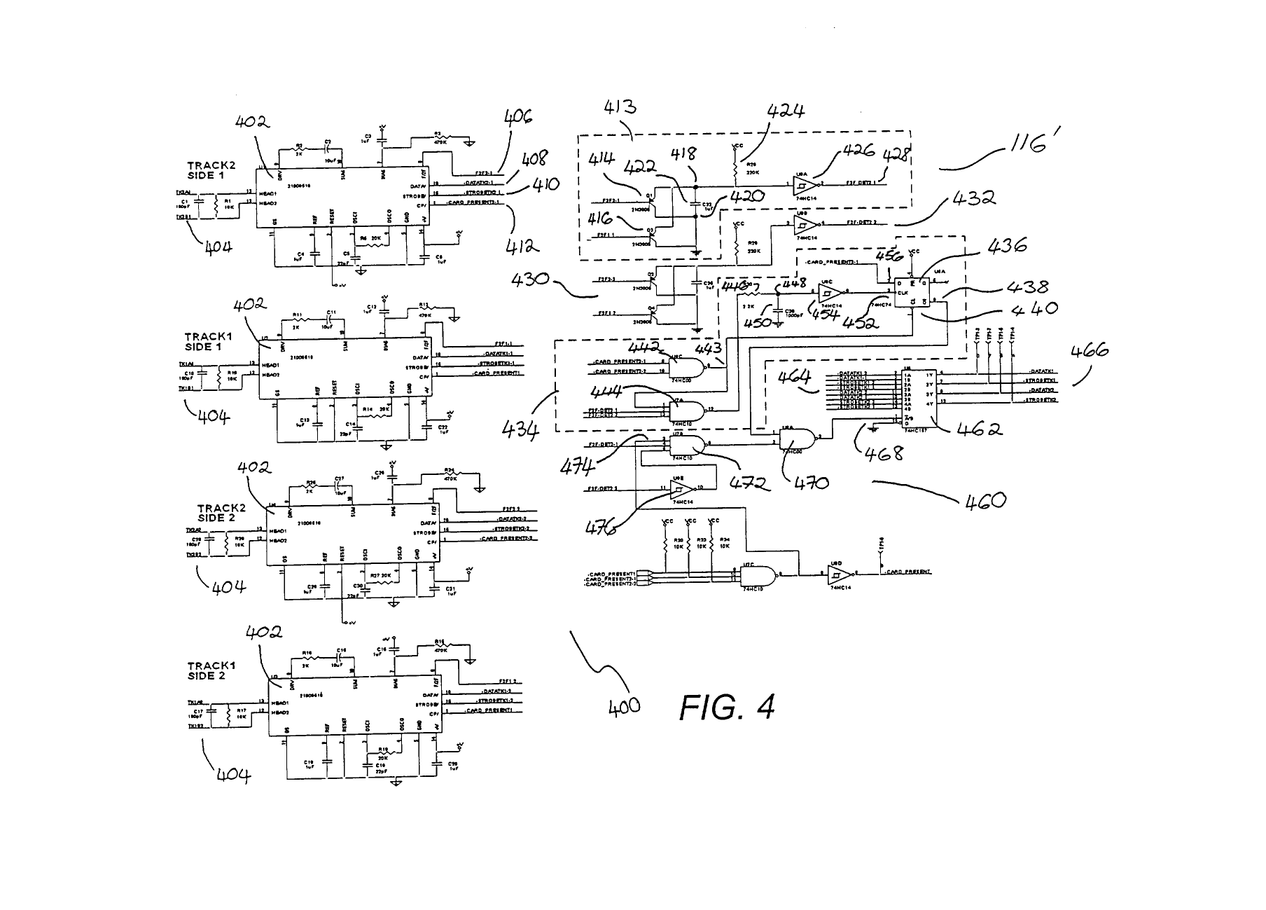

An implementation of an embodiment of a magnetic stripe reader 400 in accordance with the present invention specifically adapted for obtaining data from the ISO 7811 stripe 306 of the card 300 is illustrated in FIG. 4. The magnetic stripe reader includes two reading heads (not shown). Each of the reading heads reads data from tracks 1 and 2 of an ISO 7811 magnetic stripe and produces two outputs. Each of the outputs corresponds to the magnetic flux transitions of one of the tracks.

The amplifier/detector, bit recovery unit and density detector associated with each of the four output signals from the two reading heads are implemented using 21006515 ICs 402. The inputs 404 of the 21006515 ICs are connected to one of the four outputs from the reading heads. The outputs of the 21006515 ICs 406, 408, 410, 412 are connected to the logic unit 116′.

The output 406 is provided by the amplifier/detector circuitry within the 21006515 IC. The output is a logic 1 whenever the 21006515 IC is reset and the output toggles between logic 0 and logic 1 as flux transitions are detected by the reading head.

The output 408 is the output of the bit recovery unit of the 21006515 IC. The output 408 provides the digital data detected by the reading head to the logic unit.

The output 410 is a control signal used to synchronize the reading of data from the output 408.

The output 412 is provided by the enable/disable counter circuitry of the 21006515 ICs. In the embodiment of FIG. 4, the enable/disable circuitry performs the function of the density detectors of the embodiment of the magnetic stripe reader shown as 100 in FIG. 1. The output 412 is a logic 1 when the enable/disable circuitry is reset. The output 408 changes to a logic 0 after 6-7 flux transitions are detected at the reading head and resets to a logic 0 150 ms after the last flux transition has been detected. In other embodiments a greater or lesser number of flux transitions can cause the enable/disable circuitry to output a logic 0.

The logic unit 116′ includes a number of discrete electronic components. These discrete components are configured to enable the detection of the presence of magnetic stripes at the reading heads using the outputs 406 of the 21006515 ICs. The discrete components are also configured to determine which reading head is reading the lower density data of track 2 of a ISO 7811 magnetic stripe using the outputs 412 of the 21006515 ICs that receive track 2 signals from the reading heads. In addition, the discrete components are also configured to select the outputs 408 and 410 of the 21006515 ICs that contain the data from the ISO 7811 magnetic stripe. The components also provide the signals from the selected outputs to a decode processor (not shown).

The group of components 413 that use the outputs 406 of the 21006515 ICs to detect that a magnetic stripe is being read by the reading heads includes a first transistor 414 and a second transistor 416. The emitters of the transistors 414 and 416 are connected to a node 418 and the collectors of the transistors are connected to a second node 420.

A capacitor 422 is connected between the nodes 418 and 420. A resistor 424 connects the node 418 to the power rail and the node 420 is connected to ground.

A Schmitt trigger 426 is connected to the node 418 and provides an output 428 that depends on the voltage level at the node 418. The Schmitt trigger output 428 is a logic 0 when the capacitor 422 is charged and a logic 1 when no charge is stored in the capacitor.

The capacitor charges when the reading head connected to the 21006515 ICs, which provide inputs to the group of components 413, are not receiving data. When the 21006515 ICs are not receiving data, they provide an output voltage on the output 406 that corresponds to a logic 1, which switches the transistors 414 and 416 off. The capacitor discharges when the outputs 406 of the 21006515 ICs toggle between logic 0s and logic is. The toggling switches the transistors 414 and 416 on and causes current to discharge from the capacitor.

A Schmitt trigger output 428 of logic 1 indicates that a magnetic stripe is being read by the reading head connected to the pair of 21006515 ICs that provide inputs to the group of components 413.

A second group of electronic components 430 is connected to the outputs 406 of the pair of 21006515 ICs that are not connected to the group of components 413. The second group of components 430 is configured similarly to the group of components 413 and provides an output 432. The output 432 indicates whether a magnetic stripe is being read by the reading head connected to the pair of 21006515 ICs providing inputs to the group of components 430.

In other embodiments, the groups of electronic components 413 and 430 can be implemented using other logic devices including other types of logic gates and/or using flip-flops or buffers. In other embodiments, the groups of electronic components 413 and 430 can also be implemented using application specific integrated circuits or using a combination of discrete components, microprocessors and/or application specific integrated circuits.

The logic unit 116′ contains another group of electronic components 434 that receives inputs from the outputs 428 and 432 of the groups of components 413 and 430 in addition to the outputs 412 of the 21006515 ICs that reconstruct the track 2 data read by the reading heads. The group of components 434 includes a D-type flip-flop 436. The output of the D-type flip-flop 438 indicates which reading head is reading data from an ISO 7811 magnetic stripe. The input 440 to the D-type flip-flop clears the contents of the flip-flop. The input 440 is provided by a NAND gate 442. The two inputs to the NAND gate 442 are the outputs 412 from the 21006515 ICs that reconstruct the track 2 data read by the reading heads. The NAND gate 442 outputs a logic 1 when either of the outputs 412 are logic 0s. The NAND gate output 443 is also connected as an input to a three input NAND gate 444. The other two inputs of the NAND gate 444 are the outputs 428 and 432 of the groups of components 413 and 430. The output of the NAND gate 444 is connected to one end of a resistor 446. The other end of the resistor 446 is connected to a node 448. The node 448 is connected to ground by a capacitor 450 and is also connected to the clock input 452 of the D-type flip-flop 436 via a Schmitt trigger 454.

The NAND gate 444 has an output of logic 1 when neither of the reading heads is reading data. When both of the reading heads start reading data, the outputs 428 and 432 from the groups of components 413 and 430 become logic is and the output 443 of the NAND gate 442 is also a logic 0 but the output of the NAND gate 444 remains a logic 1. If 6-7 magnetic flux transitions are detected in track 2 by one of the reading heads, then the output 443 of the NAND gate 442 becomes a logic 1. The output of the NAND gate 442 becoming a logic 1, which removes the clear signal 440 from the D-type flip-flop 436 and causes the output of the NAND gate 444 to become a logic 0. The transition of the output of the NAND gate 444 from a logic 1 to a logic 0 causes the Schmitt trigger to clock the D-type flip-flop 436. The resistor 446 and the capacitor 450 introduce a propagation delay to ensure that the Schmitt trigger clocks the D-type flip-flop 436 after the clear signal 440 has been removed.

The D-type flip-flop 436 clocks in data from the input 456. The signal provided to the input 456 is the output 412 from one of the 21006515 ICs that reconstruct track 2 data read by the reading heads. The D-type flip-flop 436 provides the inverse of the input signal 456 to the output 438. The output 438 indicates the reading head that is reading the highest density data. An output 438 of logic 1 indicates that the reading head connected to the 21006515 IC that provided the input 456 is reading the higher density track 2 data. An output 438 of logic 0 indicates that the other reading head is reading the higher density track 2 data.

The logic unit 116′ also includes a set of discrete electronic components 460 responsible for controlling the transfer of data from the outputs 408 and 410 of the 21006515 ICs to the decode processor. The group of components 460 includes a multiplexer 462 that has inputs 464 that are connected to the outputs 408 and 410 of each of the 21006516 ICs.

The outputs 466 of the multiplexer 462 only provide the decode processor (not shown) with data from the 408 and 410 outputs of the 21006516 ICs that are connected to a reading head, which is reading data from an ISO 7811 magnetic stripe. The multiplexer 462 chooses the inputs 464 to connect to the outputs 466 based on the input signal 468. The input signal 468 is provided by the output of a two input NAND gate 470.

The inputs of the NAND gate 470 are the output signal 438 from the group of components 434 and an output signal from a three input NAND gate 472. The three inputs of the NAND gate 472 are connected to a line 474 that carries a signal indicative of whether data can be read, to the output 428 from the group of components 413 and to the output of a Schmitt trigger 476. The Schmitt trigger 476 is connected to the output 432 from the group of components 430.

If the reading head indicated by the output signal 438 of the D-type flip-flop 436 is the only reading head reading data from a magnetic stripe, then the output of the NAND gate 474 is a logic 0 and the NAND gate 470 is the same as the output 438. If the input 468 of the multiplexer 462 is the output 438, then data from the reading head indicated by the output 438 is selected by the multiplexer.

If both reading heads are reading data, then the output of the NAND gate 472 is a logic 1 and the output of the NAND gate 470 is the complement of the output 438. If the input 468 of the multiplexer 462 is the complement of the output 438, then data from the reading head that is not the reading head indicated by the output 438 is selected by the multiplexer. The data selected by the multiplexer is provided to the decode processor via the outputs 466.

In alternative embodiments of the magnetic stripe reader in accordance with the present invention, data from one out of any number of magnetic stripes can be read provided that the density of at least one track of data on that magnetic stripe is unique. In addition, embodiments of the magnetic stripe reader can include three or more reading heads and/or can read three or more tracks of data. In embodiments that include additional reading heads and/or that read three or more tracks of data, additional amplifier/detectors, bit recovery units and density detectors are provided for each additional track of magnetic data read by each additional reading head. In addition, the circuitry of the logic unit can be modified to detect when data is being read by each of the reading heads and additional flip-flops, components and/or buffers are provided to determine the relative densities of the data being read by each of the reading heads.

The embodiment of the magnetic stripe reader 400 of FIG. 4 described above is implemented using a combination of digital components and analog components. The same methods described above can also be used in alternative embodiments that are implemented entirely in analog circuits or that use combinations of other digital and analog circuits. The methods described above can also be used in alternative embodiments that are implemented using application specific integrated circuits or that are implemented using a combination of application specific integrated circuits, microprocessors and/or discrete components.

While the above description contains many specific embodiments of the invention, these should not be construed as limitations on the scope of the invention, but rather as an example of one embodiment thereof. Many other variations are possible.

What is claimed:

1. A magnetic stripe reader, comprising:
a first magnetic reading head connected to a first intermediate network;
a second magnetic reading head connected to a second intermediate network; and
a logic unit connected to the first and second intermediate networks, where the logic unit is configured to compare the rates at which flux transitions occur at the first and second reading heads.

2. The magnetic stripe reader of claim 1, wherein each magnetic reading head and intermediate network pair is configured to generate a signal indicative of the magnetic field of a magnetic stripe moving relative to the reading head.

3. The magnetic stripe reader of claim 1, wherein the first and second intermediate networks include an amplifier/detector connected to a bit recovery unit.

4. The magnetic stripe reader of claim 1, wherein:
the logic unit is configured to select one of the first or second magnetic reading heads based on the detected difference in the rate of flux transitions experienced by the magnetic reading heads; and
the logic unit is configured to output bits of information based on the flux transitions occurring at the selected magnetic reading head.

5. The magnetic stripe reader of claim 4, wherein the logic unit is configured to detect the presence of a card containing at least two magnetic stripes.

6. The magnetic stripe reader of claim 5, wherein:
the magnetic stripes on the card contain padding bits; and
the logic unit is configured to select a magnetic reading head prior to all of the padding bits on either of the magnetic stripes being read by the magnetic reading heads.

7. The magnetic stripe reader of claim 5, wherein the logic unit is configured to select one of the magnetic stripes on the card based on the density of data recorded on individual tracks of the magnetic stripes.

8. A magnetic stripe reader, comprising:
means for detecting bits of data recorded in a first track of magnetic data;
means for detecting bits of data recorded in a second track of magnetic data;
means for detecting a difference in the density with which bits are recorded in the first track of magnetic data and the density with which bits are recorded in the second track of magnetic data.

9. A method of reading desired data from a magnetic stripe, comprising the steps of:
analyzing flux transitions recorded on a track of data on each of a first magnetic stripe and a second magnetic stripe; and
using the measured flux transitions to identify the magnetic stripe containing the desired data.

10. The method of claim 9, further comprising the steps of:
detecting the presence of more than one magnetic stripe; and
reading the desired data from the magnetic stripe identified as containing the desired data.

11. The method of claim 10, wherein:
the data contained on each of the magnetic stripes includes a number of padding bits; and
said analyzing step further comprises the steps of:
simultaneously reading the flux transitions corresponding to padding bits on each of the magnetic stripes; and
counting the number of bits read from each of the magnetic stripes.

12. The method of claim 11, wherein said analyzing step further comprises the step of comparing the bit counts of each of the magnetic stripes.
